(19) United States
(12) Patent Application Publication
(10) Pub. No.: US 2025/0274448 A1
(43) Pub. Date: Aug. 28, 2025

(54) METHOD AND SYSTEM FOR OPTIMISING OTP CHANNELS IN DIGITAL VERIFICATION

(71) Applicant: Yoel Hartanto KEREH, Jakarta (ID)

(72) Inventor: Yoel Hartanto KEREH, Jakarta (ID)

(21) Appl. No.: 18/555,133

(22) PCT Filed: Apr. 14, 2022
(86) PCT No.: PCT/IB2022/053505

§ 371 Date: Oct. 12, 2023

(30) Foreign Application Priority Data
Apr. 21, 2021 (ID) S00202102927

(51) Int. Cl. H04L 9/40

(52) U.S. Cl. CPC H04L 63/0838

(57) ABSTRACT

A system and method for one time password (OTP) channel optimization is provided. The method includes: for each of a plurality of optimization criteria, and based on at least one attribute of a plurality of OTP channels, ascertaining a recommendation of the OTP channels, thereby ascertaining a plurality of recommendations for the plurality of optimization criteria respectively; in response to a verification request comprising an end user identifier, and based on at least one attribute of the end user identifier, selectively providing a first recommendation wherein the recommendations include the first recommendation; in response to a selected first OTP channel which is included in the first recommendation, instructing for a first OTP to be provided via the first OTP channel to a first device associated with the end user identifier wherein the OTP channels include the first OTP channel; and validating a first OTP entry against the first OTP.

### RELATED APPLICATION

The present application claims priority to Indonesia patent application number S00202102927 titled “Digital Verification or Validation” filed on 21 Apr. 2021 which is incorporated by reference herein in its entirety.

### TECHNICAL FIELD

The present disclosure relates to the field of computer-implemented technologies, particularly verification and/or validation of identity, channel optimization techniques for verification or validation of identity, and systems thereof.

### BACKGROUND

There is an increasing need for verification and validation solutions that are simple, secure, rapid, precise, and/or economical.

In general, verification is necessary to ensure an end user's identity is correct and can receive proper service, and prevent abuse or unscrupulous persons from attempting to steal or impersonate another owner's identity for various motives. Existing techniques of verification and validation are implemented via a random temporary code, e.g. one time password (OTP), which may be sent via a mechanism or channel, e.g. brief messages, missed calls as codes, Short Message Service (SMS), telephone, biometrics, and face detection, among others.

The approach and flow of the verification process have a significant impact on the quality of the verification service. The majority of existing systems employs a single technique with an inefficient flow. However, relying on a single technique is disadvantageous as each end user can possibly be contacted more successfully via a variety of channels. Using a single technique and an inefficient verification flow would render user verification and validation ineffective and inefficient.

### SUMMARY

An objective of the present disclosure is to make verification or validation procedures more efficient and effective, from the initial process of acquiring identification data through the final process of data matching. There are three primary stakeholders in the present disclosure: digital verification system service providers, e.g. central proxy; end users, e.g. individuals or end consumers; and service users, e.g. merchants, banks, which are digital verification system service users as well as applicant owners having identity data to verify, such as telephone numbers and/or identification numbers and/or email addresses and/or other identifiers, who wish to verify security either from a newly filled form or from their existing data collection. Service users transmit specific data such as codes or other identifiers to the digital verification system service providers in order to match the data. Additionally, digital verification system service providers may give specific data to assist service consumers. This process can be repeated if the previous verification failed using the same or a different approach, or it can be restarted from the beginning according to a smart verification system's filters and logic. An objective of the smart verification system is to send verifications that are as accurate, secure, dependable, and/or cost-effective as possible. This method may be used automatically or manually, and includes intelligent and customisable repeat buttons to ensure the best and safest verification experience possible. When active, service user can utilize the system to enter a unique code received via misscall OTP by reading the end user's mobile phone's call history. The advantage of this system is that it improves the efficiency and stability of verification for service user by optimizing the verification process and automatically regulating the best and safest verification methods and procedures. Verifying and validating end users can be more accurate when using the methods and system of the present disclosure.

In an aspect of the present disclosure, a method for one time password (OTP) channel optimization is provided. The method comprises:
for each of a plurality of optimization criteria, and based on at least one attribute of a plurality of OTP channels, ascertaining a recommendation of the OTP channels, thereby ascertaining a plurality of recommendations for the plurality of optimization criteria respectively;
in response to a verification request comprising an end user identifier, and based on at least one attribute of the end user identifier, selectively providing a first recommendation wherein the recommendations include the first recommendation;
in response to a selected first OTP channel which is included in the first recommendation, instructing for a first OTP to be provided via the first OTP channel to a first device associated with the end user identifier wherein the OTP channels include the first OTP channel; and
validating a first OTP entry against the first OTP.

In an aspect of the present disclosure, a central proxy comprises:
at least one computer processor, a memory storage which is communicably coupled thereto and stores computer executable instructions that, when executed by the computer processor, cause the computer processor to:
for each of a plurality of optimization criteria, and based on at least one attribute of a plurality of OTP channels, ascertains recommendation of the OTP channels, thereby ascertaining a plurality of recommendations for the plurality of optimization criteria respectively;
in response to a verification request comprising an end user identifier, and based on at least one attribute of the end user identifier, selectively provide a first recommendation wherein the recommendations include the first recommendation;
in response to a selected first OTP channel which is included in the first recommendation, instruct for a first OTP to be provided via the first OTP channel to a first device associated with the end user identifier wherein the OTP channels include the first OTP channel; and
validate a first OTP entry against the first OTP.

In an embodiment of the above aspect(s), in response to and based on a failed validation of the first OTP, a second recommendation is selectively provided wherein the recommendations includes the second recommendation;
in response to a selected second OTP channel which is included in the second recommendation, a second OTP is instructed to be provided via the second OTP channel to the first device or a second device associated with the end user identifier wherein the OTP channels include the second OTP channel.

In an embodiment of the above aspect(s), based on a validation outcome of the first OTP and/or the second OTP, the at least one attribute of the OTP channels is modified.

In an embodiment of the above aspect(s), in response to and based on a failed validation of the first OTP, an OTP entry of the failed validation is ascertained similar to the first OTP;
another OTP is instructed to be provided via the first OTP channel to the first device associated with the end user identifier.

In an embodiment of the above aspect(s), instructing for a first OTP to be provided via the first OTP channel to a first device associated with the end user identifier includes instructing for the first OTP to be auto-populated as OTP entry.

In an embodiment of the above aspect(s), the optimization criteria include at least two selected from the group of: security of OTP channel, accessibility of OTP channel, success rate of OTP channel, and usage cost of OTP channel.

In an embodiment of the above aspect(s), the at least one attribute of the plurality of OTP channels is selected from the group of: static OTP channel characteristic, real-time usage cost of OTP channel, delivery rate of OTP channel, validation success rate of OTP channel, and usability of OTP channel

In an embodiment of the above aspect(s), the at least one attribute of the end user identifier includes a count of OTP authentication attempts associated with the end user identifier over a predetermined time period.

In an embodiment of the above aspect(s), the end user identifier is validated against a database which includes a historical profile associated with the end user identifier;
based on the historical profile, the end user identifier is prioritized or de-prioritized.

In an embodiment of the above aspect(s), the OTP channels include at least two selected from the group of: SMS, voice call, missed call, messaging application, authenticator application, electronic mail.

In an embodiment of the above aspect(s), the first OTP is a missed call, the method further comprising: automatically providing at least a part of a caller number of the missed call as the first OTP entry, wherein the missed call is received within a predetermined duration or count.

In an embodiment of the above aspect(s), a success rate of missed call OTP may be optimized by performing at least one of the following: monitoring a delivery status of the first OTP, detecting a dial tone, a busy tone or a voice, and ascertaining a duration of the missed call.

### BRIEF DESCRIPTION OF DRAWINGS

FIG. 1A is a schematic diagram illustrating a system architecture which includes a central proxy, e.g. proxy gateway server, according to one embodiment;

FIG. 1B is a flow sequence implementable at the system architecture of FIG. 1A, according to one embodiment;

FIG. 1C is a flow sequence implementation by a central proxy;

FIGS. 2A, 2B, and 2C show flow sequences implementable among end user(s), service user(s), a central proxy, and/or channel vendor(s);

FIG. 2D shows a flow sequence for a filtering procedure implementable by a central proxy;

FIG. 3A shows auto-population of an OTP entry when miss call channel is used;

FIG. 3B shows a flow sequence for ascertaining success rate of miss call.

### DETAILED DESCRIPTION

In the following description, numerous specific details are set forth in order to provide a thorough understanding of various illustrative embodiments of the invention. It will be understood, however, to one skilled in the art, that embodiments of the invention may be practiced without some or all of these specific details. In other instances, well known process operations have not been described in detail in order not to unnecessarily obscure pertinent aspects of embodiments being described. In the drawings, like reference numerals refer to same or similar functionalities or features throughout the several views.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, including examples and claims, the articles “a”, “an” and “the” as used with regard to a feature or element include a reference to one or more of the features or elements. The terms “comprising,” “including,” and “having” are intended to be open-ended and mean that there may be additional features or elements other than the listed ones. The term “and/or” includes any and all combinations of one or more of the associated listed items.

The term “device” refers to any electronic device with computing and communication capability, e.g. smart phone, laptop or notebook or desktop computer, tablet, server computer, cloud server, edge computer, Internet of Thing (IoT) object, etc.

The term “computer processor” refers to any type of digital processing apparatus.

The term “end user” refers to an individual to be authenticated or verified, and/or may refer to the end user's device, e.g. smart phone, laptop or notebook or desktop computer, tablet, etc.

The term “service user” refers to a digital verification system service user which may be represented by an entity and/or its device, which provides services to end users via its application and may have an interest in optimizing OTP channel selection. Thus, service users may be application owners. Examples of service user include banks and merchants. The term “application” or “App” refers to installed software, website, portal, platform for accessing services provided by or related to the service user.

The term “central proxy” refers to a digital verification system service provider which may be represented by an entity and/or its device, which provides method for optimizing OTP channel from initiation to finalization of end user verification on the service user's side. The central proxy also provides services on various channels in each authentication service with a choice of various channel vendors that can be selected by the service user. The central proxy may include at least one computer processor, and at least one memory storage which is communicably coupled thereto and stores computer executable instructions that, when executed by the computer processor, cause the computer processor to perform at least some of the methods/steps described herein. As the memory storage may also store database(s) referred to herein, references to memory storage may include references to database(s). The central proxy may further include a communication unit configured to send and/or receive data to and/or from other entities or devices.

The term “channel vendor” refers to an entity and/or its device which generates and provides OTPs to end users through one or more OTP channels.

The term “OTP” or “one-time password” or “one-time passcode” refers to a password or passcode which has limited validity, e.g. for one-time use or one transaction, with or without time limitation.

The term “recommendation” refers to one or more OTP channel options ascertained by OTP channel optimization method according to the present disclosure.

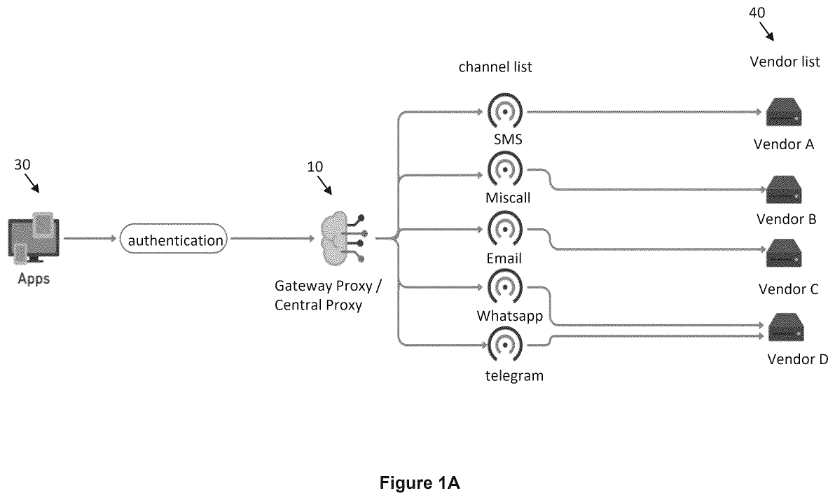

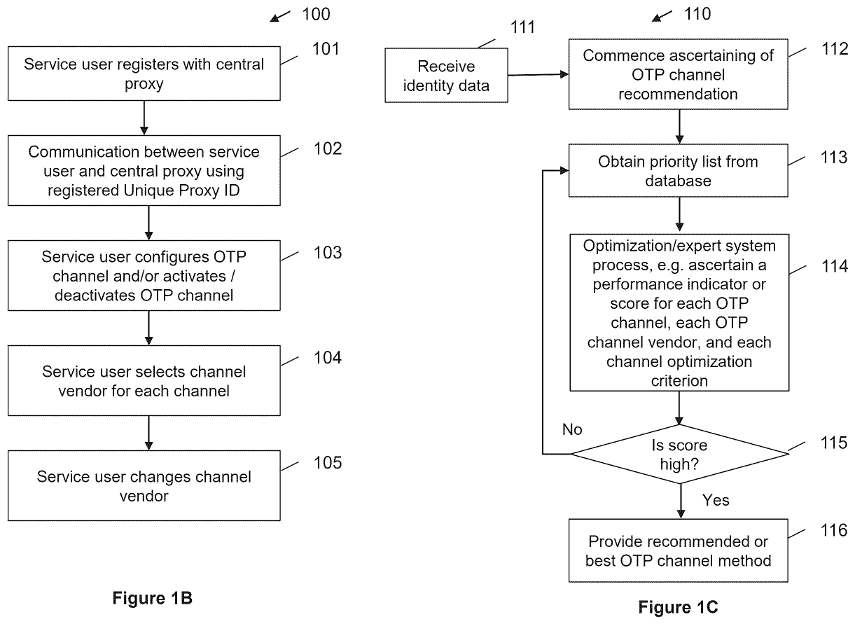

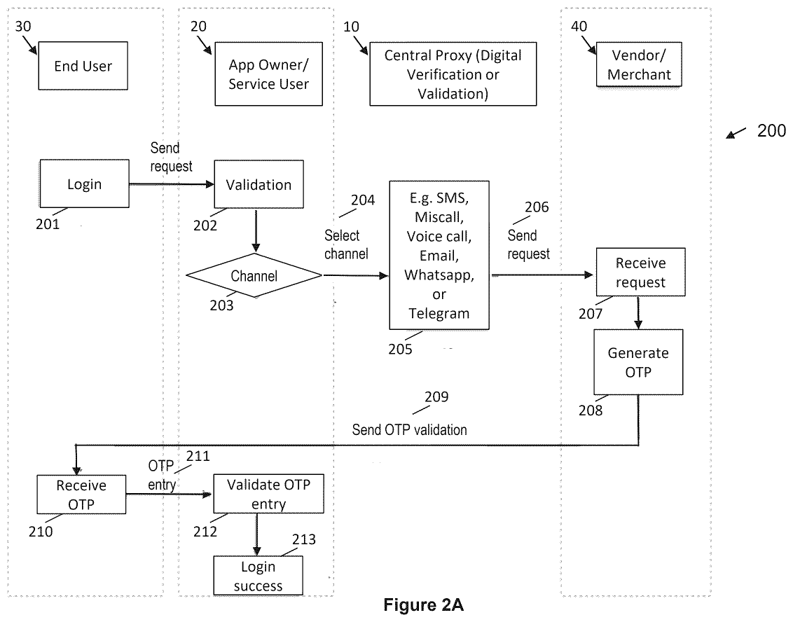

FIG. 1A is a schematic diagram illustrating a system architecture which includes a central proxy 10, e.g. proxy gateway server, according to one embodiment. The central proxy is configured to communicably couple with a plurality of end user devices 30, including applications (Apps) running on the end user devices 30. The central proxy 10 is further configured to communicably couple with a plurality of channel vendors 40 which provide a plurality of OTP channels respectively. The central proxy 10 may be further configured to communicably couple with a database, e.g. central proxy database.

FIG. 1B is a flow sequence 100 implementable at the system architecture of FIG. 1A, according to one embodiment. In block 101, a service user, e.g. its application, Internet of Things (IoT) object, sends a registration request to the central proxy or the central proxy database. The registration request includes a Unique Proxy identifier (ID) which is associated with the service user and may be used for sending verification requests to the central proxy. In block 102, after the service user is registered in the central proxy database, the Unique Proxy ID may be used for communication with the central proxy such as using the Hypertext Transfer Protocol Secure (HTTPS) protocol. In block 103, using the registered Unique Proxy ID, the service user may configure the OTP channel type according to the initial requirements of the application. OTP channels can be activated and deactivated dynamically using an integration algorithm using the central proxy as the main path. In block 104, after selecting the available channels, the service user selects a channel vendor for each channel. Service users may select channel vendor based on attributes, e.g. pricing, success rate, reliability, and reviews and ratings, of each vendor. In block 105, the service user may change channel vendor at any time without having to change integration algorithm. The service user may select one or more channel vendors in order of priority for each channel. The order of selecting channel vendors in one channel determines the priority of their use, the rest will be backups which will become active if the prioritized channel vendor(s) are unavailable.

In some examples of blocks 103, 104, and/or 105, the central proxy may perform OTP channel optimization methods according to optimization criteria, e.g. service user's priority or requirements which may be predetermined. Optimization criteria may include cost, success rate, security, and/or accessibility of OTP channels. For each criterion, the central proxy may ascertain a performance indicator or score of each OTP channel based on its attributes which may include channel characteristic, usage cost, delivery rate, validation success rate, and/or usability. The attributes may be weighted. The attributes may be static or dynamic. Static attributes may include channel characteristic, e.g. device density based on channel type, security weights. Dynamic attributes may be collected in real time and may be continually or periodically modified based on collected data, e.g. from completed verification requests, validation outcome(s). Dynamic attributes may include live price data for each OTP channel and channel vendor, delivery rates from OTP channels and channel vendor, verification success rate, and indicators of ease of use from the end user side.

Based on the ascertained performance indicator or score, the central proxy may ascertain a recommendation of one or more OTP channels for each optimization criterion. Accordingly, if there are multiple optimization criteria, multiple recommendations of OTP channels would be ascertained respectively.

All optimization requirements may be activated simultaneously using the order of priority to ascertain most optimized or best method. The process of selecting an optimized verification method may be determined by the weight of each attribute.

### Illustrative Example: Station-O

An illustrative example of channel optimization is provided herein using a mobile application with the name Station-O for buying and selling stationery and office equipment. For illustrative purpose, cost optimization is selected for the application's OTP service. In year 2021, Station-O had 50,000 users and OTP usage count reached 200,000 times. As OTP channel used was SMS and cost per OTP was Indonesian Rupiah (IDR) 550, the annual cost was IDR 110,000,000, without channel optimization. If Station-O then employs channel optimization criteria with the order of priority (1) cost, (2) success rate, (3) security, (4) accessibility, channel optimization and costs would be set out below.

When the service user prioritises cost optimization, the central proxy will ascertain a performance indicator or score and OTP channel recommendation according to the knowledge base as follows.

(1) Price method

| | Vendor | | |
|---|---|---|---|
| Price | Alphine (IDR) | Star (IDR) | North (IDR) |
| WhatsApp | 20 | 30 | 50 |
| Biometric | 300 | 300 | 300 |
| Header enrichment | 180 | 220 | 200 |
| Missed call | 170 | 200 | 210 |
| SMS | 550 | 650 | 550 |

(2) Success rate method

| | Vendor | | |
|---|---|---|---|
| Success rate | Alphine (%) | Star (%) | North (%) |
| WhatsApp | 40 | 52 | 85 |
| Biometric | 40 | 30 | 55 |
| Header enrichment | 60 | 30 | 50 |
| Missed call | 92 | 88 | 80 |
| SMS | 78 | 70 | 77 |

(3) Security rate from analytic of each vendor

| | Vendor | | |
|---|---|---|---|
| Security rate | Alphine (%) | Star (%) | North (%) |
| WhatsApp | 80 | 78 | 85 |
| Biometric | 80 | 82 | 88 |
| Header enrichment | 83 | 89 | 84 |
| Missed call | 85 | 86 | 84 |
| SMS | 85 | 83 | 84 |

(4) Accessibility rate

| | Vendor | | |
|---|---|---|---|
| Accessibility rate | Alphine (%) | Star (%) | North (%) |
| WhatsApp | 80 | 78 | 85 |
| Biometric | 80 | 82 | 88 |
| Header enrichment | 83 | 88 | 84 |
| Missed call | 85 | 86 | 84 |
| SMS | 91 | 92 | 93 |

Based on the above knowledge base ascertained for each OTP channel and each channel vendor, OTP channel optimization may be performed using the following sequence or logic:
(i) If the user makes an OTP request for the first time, WhatsApp channel will be recommended with Alpine vendor to be used in the first verification attempt so that cost optimization can be achieved.
(ii) If the first verification attempt using WhatsApp OTP fails, missed call channel will be recommended with Alphine vendor to be used in the second verification attempt in view of the best possible success rate.
(iii) If the second verification attempt using missed call fails, header enrichment will be recommended with Star vendor to be used in the third verification attempt in view of the best possible security rate.
(iv) If the third verification attempt using header enrichment fails, SMS will be recommended with North vendor to be used in the fourth verification attempt in view of the best possible accessibility rate.

With channel optimization, cost recapitulation of Station-O is provided as follows:

| Optimisation | | | | Cost per | |
|---|---|---|---|---|---|
| priority | Channel | Vendor | No. of OTP | OTP (IDR) | Total cost |
| Cost | WhatsApp | Alphine | 40,000 | 20 | 800,000 |
| Success rate | Missed call | Alphine | 80,000 | 170 | 13,600,000 |
| Security rate | Header | Star | 20,000 | 220 | 4,400,000 |
| | enrichment | | | | |
| Accessibility | SMS | North | 60,000 | 550 | 33,000,000 |

| | |
|---|---|
| Total | 51,800,000 |

With channel optimization, OTP costs for Station-O are predicted at DR 51,800,000 which would meet the DR 110,000,000 OTP needs without channel optimization. Hence, with channel optimization, Station-O's cost savings on OTP costs in one year are DR 58.200.000 or 52.9% as compared to costs without channel optimization. Furthermore, the cost savings may be achieved in addition to ensuring certain level of success rate, security rate and accessibility rate according to service user's defined priority.

In some other examples, the above order of priority may be adjusted or interchanged. In some other examples, if the verification attempts fail, the end user may be suspended from further verification attempts or identified as a threat.

FIG. 1C is a flow sequence 110 implementable in the above-described illustrative example Station-O. In block 111, the central proxy receives a Unique Proxy ID from an application and a request for verification. In block 112, the central proxy commences ascertaining of OTP channel recommendation in accordance with OTP channel optimization method of the present disclosure. In block 113, the central proxy retrieves a priority list from a database which provides the service user's order of priority. In block 114, the central proxy executes an optimization or expert process which may include ascertaining a performance indicator or score for each OTP channel, each OTP channel vendor, and each channel optimization criterion. The optimization process may ascertain performance indicator or score, e.g. ascertain cost recapitulation, with channel optimization according to the priority list. In block 115, if the ascertained performance indicator or score is ascertained as high, e.g. highest among available OTP channels and/or OTP channel vendor, or higher than a predetermined threshold value or a previous value, the flow sequence 110 proceeds to block 116. In block 116, the central proxy provides or presents a recommendation of OTP channel(s), e.g. the OTP channel with high performance indicator or score, or a list of OTP channels in order of recommendation. In block 115, if the ascertained performance indicator or score is ascertained as not high, the flow sequence 110 proceeds to block 113 to re-retrieve a priority list and then to block 114 to re-ascertain performance indicators or scores.

It is to be appreciated that a sequence or logic for providing a recommended OTP channel according to verification attempt count, as described in the above illustrative example Station-O, may be incorporated in block 114 or block 116 or elsewhere, e.g. block 203.

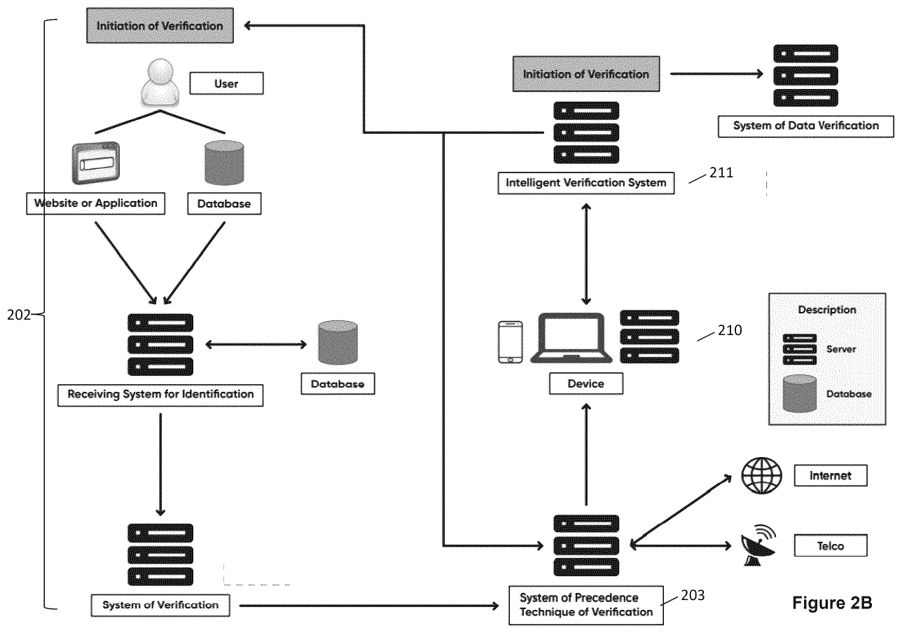

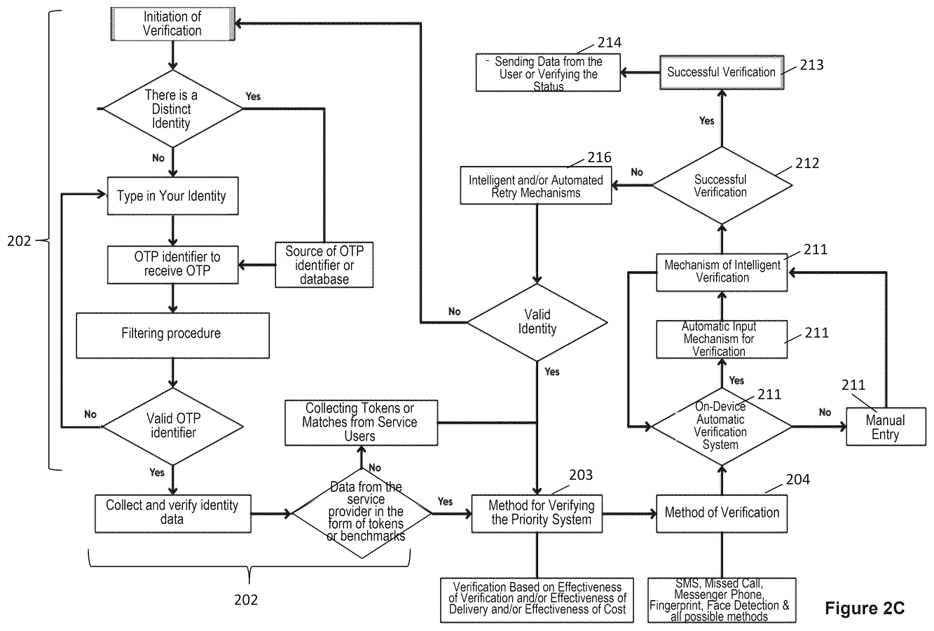

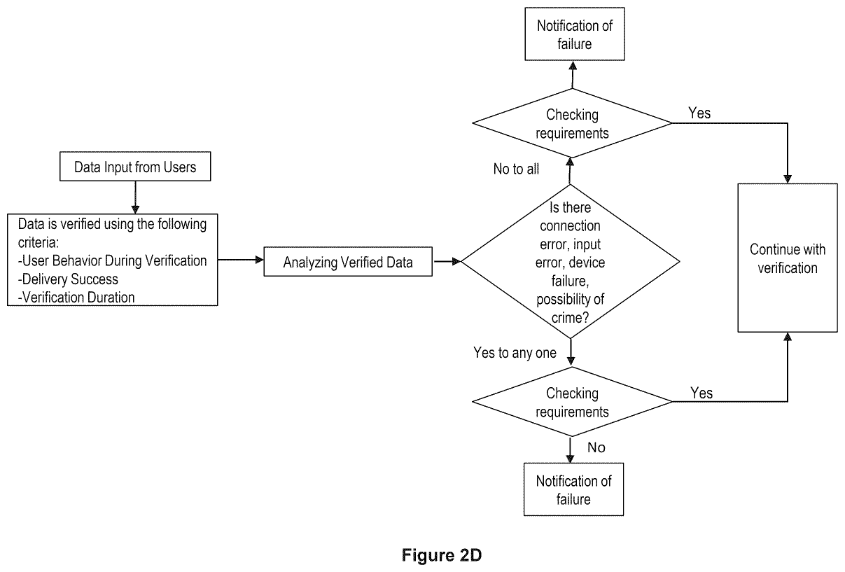

FIG. 2A is a flow sequence 200 implementable among end user(s) 30, service user(s) 20, a central proxy 10, and channel vendor(s) 40. Prior to executing flow sequence 200, the central proxy 10 may have ascertained a plurality of recommendations of OTP channels for a plurality of optimization criteria respectively, as described in the foregoing. The recommendations may be modified during and/or after executing flow sequence 200.

In block 201, service users 20 may provide login forms in their applications, e.g. mobile app, websites, which are configured to receive verification initiation requests.

In block 202 of FIGS. 2A, 2B and 2C, an end user 30 initiates a verification request via an application.

Referring to FIGS. 2B and 2C, the end user 30 provides an end user identity, e.g. mobile phone number, identification card number, email address, account name, payment card number, etc., to the service user. The end user identity may be equivalent to, or separate from, or may include the end user's OTP identifier. If the service user 20 has access to a database of end user identities and their corresponding OTP identifiers, e.g. mobile phone, email address, for receiving OTPs, the end user 30 may not be required to provide his OTP identifier as the application may retrieve the corresponding OTP from the service user database. Otherwise, the end user 30 may be required to provide his OTP identifier (see FIGS. 2B, 2C).

The end user identifier may be filtered to ascertain whether it is to be accepted or rejected, and/or prioritized or de-prioritized. A filtering procedure may include matching the end user identifier against a database or system logic, e.g. length of identifier, blocked records, end user behavior when entering the identifier, and/or time of identifier entry. For example, the filtering procedure may reject an end user identifier if it has an unfavourable historical profile in a database; on the other hand, the filtering procedure may prioritize an end user identifier if it has a record of favourable history in a database. For example, if the end user identifier has an incorrect prefix, e.g. country, phone number type, or digit lengths that do not match the country code or phone number type, or registered repetitive verification requests in a recent time period, and/or has a pattern of spam or abnormal behavior, the filtering procedure may reject the end user identifier; on the other hand, the filtering may accept an end user identifier if the foregoing conditions are not detected. If the end user identifier is rejected, the end user may be required or prompted to provide a separate end user identifier which will be subject to the filtering procedure.

The filtering procedure may be performed by at least one computer processor, e.g. of the service user 20 or central proxy 10, which may be communicably coupled with at least one database having stored end user identifiers and associated history, etc.

In an example of filtering procedure, see FIG. 2D, the end user identifier may be analysed in relation to user behavior during verification, delivery success, and/or verification duration. If any one of the parameters of connection error, input error, device failure, and probable crime fails, a further checking of requirements, e.g. a more extensive user identification check, may be performed. If the further checking fails, the verification request fails without further proceeding to issue OTP in which case a notification of failure will be provided, but if the further checking passes, the user verification request continues. If none of these parameters of connection error, input error, device failure, and probable crime fails, a further checking of requirements may be performed. If this further checking fails, the verification request fails without further proceeding to issue OTP in which case a notification of failure will be provided but if the further checking passes, the user verification request continues.

An initial or first authentication factor may take place, e.g. the end user 30 enters a password, secret information, private key, token, or comparison data.

The first authentication factor may be executable by at least one computer processor, e.g. of the service user 20, which may be communicably coupled with at least one database having stored end user identities and associated passwords, etc.

In block 203 of FIGS. 2A, 2B and 2C, if the initial or first authentication factor is successful, and based on at least one attribute of the end user, the central proxy 10 selectively provides at least one recommendation for a subsequent or second authentication factor. The attribute of the end user 30 may be a count of OTP authentication attempts associated with the end user identifier over a predetermined time period, previous selection of OTP channel, etc. The at least one recommendation may be provided, e.g. displayed, as a recommendation of OTP channels as ascertained by the central proxy 10. Various ways for presenting the recommendation of OTP channels may be envisaged, e.g. a list of a plurality of available OTP channels in order of recommendation, a plurality of available OTP channels with respective recommendation, ranking or priority, a most recommended available OTP channel, a plurality of recommended available OTP channels. It is to be appreciated that other ways for presenting the recommendation may be provided.

OTP channels may include SMS, voice call, miss voice call, messaging application, non-messaging application, and electronic mail. Examples of messaging application include WhatsApp, Telegram. Examples of non-message application include authenticator application. The OTP may be provided as text, number, alphanumeric string, machine-generated code such as QR code, biometric features such as fingerprint, face, and voice.

Referring to FIGS. 2B and 2C, this ascertaining and provision of at least one recommendation for a subsequent or second authentication factor may be performed by at least one computer processor which may be communicably coupled with at least one database having stored recommendations. This at least one computer processor, e.g. of the central proxy 10 or both the central proxy 10 and service user 20, may retrieve an appropriate recommendation and, possibly in combination with a communication unit communicably coupled thereto, send the recommendation to the end user device either directly or via the application.

In block 204 of FIGS. 2A, 2B and 2C, the end user selects one of the available OTP channels of the provided recommendation. Selection of OTP channel for the subsequent or second authentication factor may be made based on the end user's needs and availability. Hence, the selected OTP channel may or may not be the most recommended OTP channel in the recommendation. The end user's selection is sent to the application.

Referring to FIGS. 2B and 2C, this provision of selected channel option to the application may be performed by the end user device, possibly in combination with a communication unit communicably coupled thereto, to at least one computer processor, e.g. of the service user.

In block 205 of FIGS. 2A, 2B and 2C, the application sends the end user's selection to the central proxy which receives the end user's selection.

Referring to FIGS. 2B and 2C, this provision of user's selection to the central proxy may be performed by a computer processor, e.g. of the service user, possibly in combination with a communication unit communicably coupled thereto, to another computer processor, e.g. of the central proxy, possibly in combination with a communication unit communicably coupled thereto.

In block 206 of FIGS. 2A, 2B and 2C, based on and in response to the end user's selection, the central proxy sends an OTP request to a channel vendor associated with the selected OTP channel. The OTP request may include instructions for the channel vendor to provide OTP to the end user device via the selected OTP channel. The channel vendor may be pre-selected by the central proxy.

Referring to FIGS. 2B and 2C, this sending of OTP request to channel vendor, including instructing the channel vendor to provide OTP to the end user device via the selected OTP channel, may be performed by a computer processor, e.g. of the central proxy, possibly in combination with a communication unit communicably coupled thereto.

In block 207 of FIGS. 2A, 2B and 2C, the channel vendor receives an OTP request from the central proxy.

Referring to FIGS. 2B and 2C, this receipt of OTP request may be performed by a computer processor, e.g. of the channel vendor, possibly in combination with a communication unit communicably coupled thereto.

In block 208 of FIGS. 2A, 2B and 2C, in response to the OTP request, the channel vendor generates an OTP according to a predetermined format.

Referring to FIGS. 2B and 2C, this generation of OTP may be performed by a computer processor, e.g. of the channel vendor.

In block 209 of FIGS. 2A, 2B and 2C, the channel vendor directly sends the OTP to the end user, in particular the end user device, via the selected OTP channel. The channel vendor also sends the OTP to the central proxy.

Referring to FIGS. 2B and 2C, this sending of OTP may be performed by a computer processor, e.g. of the channel vendor, possibly in combination with a communication unit communicably coupled thereto. This receipt of OTP may be performed by the end user device and also by a computer processor, e.g. of the central proxy, possibly in combination with a communication unit communicably coupled thereto.

In block 210 of FIGS. 2A, 2B and 2C, the end user device, receives the OTP, e.g. code, link.

In block 211 of FIGS. 2A, 2B and 2C, the end user, in particular the end user device, provides an OTP entry to the application which sends the received OTP entry to the central proxy.

Referring to FIGS. 2B and 2C, the OTP entry may be provided to the application manually by the end user or auto-populated by an input mechanism. This sending of OTP entry may be performed by a computer processor, e.g. of the service user, possibly in combination with a communication unit communicably coupled thereto.

In block 212 of FIGS. 2A, 2B and 2C, the central proxy verifies or validates whether the OTP entry matches the OTP received from the channel vendor. If they match, validation of the OTP entry is successful, i.e. the subsequent or second authentication factor is successful.

Referring to FIGS. 2B and 2C, the OTP verification or validation may be performed by a computer processor, e.g. of the central proxy.

In block 213, the verification request is successfully completed when both authentication factors are successful.

In block 214, data associated with the verification request may be provided to one or more parties, e.g. service user, central proxy, etc., and stored as historical profile associated with the relevant party.

If the subsequent or second authentication factor fails, the block 212 proceeds to block 216 in which a retry procedure will be implemented.

In block 216, the retry procedure ascertains next step(s) based on one or more data, e.g. status of the OTP entry, selected delivery method, and/or number of attempts performed. The next step(s) may be a re-enactment of the initiation, re-verification from the beginning, e.g. block 202, using the same or a different method, or notifying the end user. Repeated verification can be carried out automatically or manually. To identify when it needs to be repeated automatically, the retry procedure may determine this immediately or independently of the user, e.g. the retry procedure can be automated to adjust the speed and duration of attempts based on the behavior of submitting and reverting verification requests. For instance, if authentication still fails after more than two attempts, the end user may be requested to verify the mobile phone number again and restart the procedure from the beginning. If it is detected that repeated attempts are unreasonable, the situation can be improved by employing more secured approaches. If the preceding approach fails to detect the delivery status, it can be repeated automatically or manually using the same way or another method, e.g. after using an OTP missed call, a short message OTP can be used.

The retry procedure may be performed by a computer processor, e.g. of the central proxy.

In some examples, in response to and based on a failed validation of OTP, a second recommendation is selectively provided based on pre-determined logic such as logic described in the above illustrative example Station-O. Blocks 203 to 212 may be performed in which the end user selects one of the available OTP channels of the second recommendation; the user selection is sent to the central proxy which sends a second OTP request to a channel vendor associated with the current selection of OTP channel; the channel vendor receives the second OTP requests, generates a second OTP and sends the second OTP to the end user device as well as to the central proxy; the central proxy receives the end user's second OTP entry and verifies whether the second OTP entry matches the second OTP. In some examples, the second recommendation is provided to the end user's second device which is associated with the end user identity and is distinct from the end user's first device which received the first recommendation.

In some examples, the central proxy may also ascertain security, convenience, and speed of user verification. During verification, the central proxy may examine the OTP entry data pattern, behavior, and duration. The central proxy may restrict the number of OTP entry attempts in order to improve the security, convenience, and efficacy of verification. For instance, if the received OTP entry is slightly different, extra tests may be performed, e.g. if the correct OTP is 1111 but the received OTP entry is 1112, an additional attempt can be performed. In other words, if validation of the first OTP fails but the OTP entry of the failed validation is similar to the first OTP, the central proxy may instruct for another OTP to be provided via the first OTP channel to the end user. However, if the difference is significant, the attempt may be limited, e.g. if the correct OTP is 1111 but the received OTP is 5678, the number of attempts may be limited to one or two.

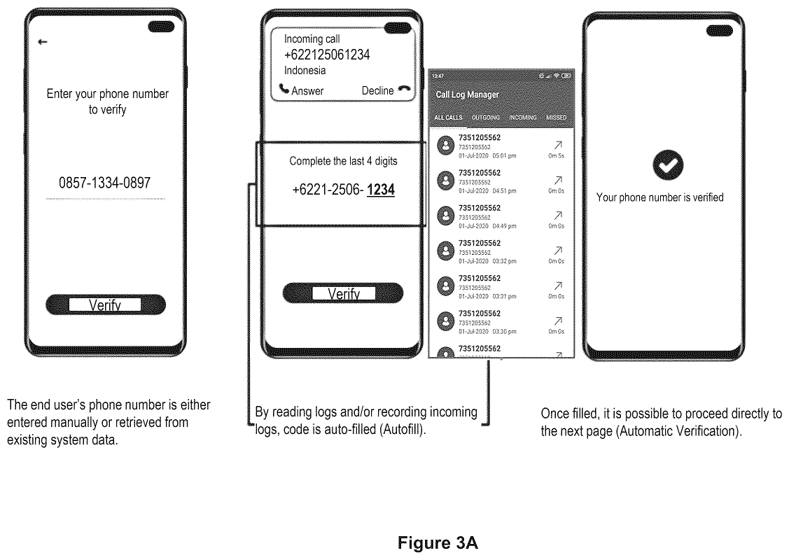

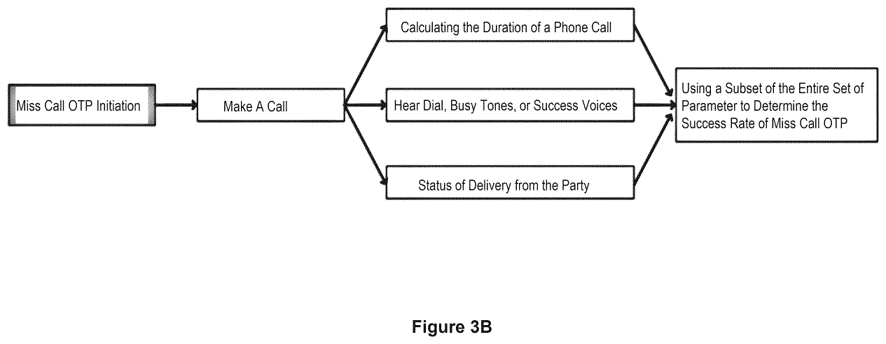

In some examples, the OTP is a missed or unanswered call. Phone call history may be used to populate the OTP automatically with at least a part of the caller number of the missed call (see FIG. 3A). Alternatively, missed call OTP may be compared with phone call history, which can be obtained or retrieved in entirety (whole) or in part, based on a predetermined duration (time range) or count (the number) of recent calls, in order to obtain the quickest and most exact match. Verification can be carried out automatically without user intervention, or additional processes can be added if necessary. For instance, when an OTP missed call is received, it may be matched against a predetermined count and/or duration, e.g. three phone records covering the last two minutes, thus obviating the need to review all data. Verification can be carried out automatically without user intervention, or additional processes, e.g. pressing of OK button, can be added if necessary.

Optimization of the OTP missed call system's success rate may be accomplished by monitoring the delivery status of the missed call, listening to or detecting a received voice, dial tone or a busy tone and/or imposing or ascertaining a time limit on the duration of the call in order to optimize the sending method using OTP missed call (see FIG. 3B). By obtaining an OTP from a missed call or by obtaining status from an existing phone from the network owner, an end user, or any party may be capable of providing phone status. To ascertain whether an OTP missed call was successful or unsuccessful, it can be detected whether if there is a dial tone or if the end user is occupied on the phone. The duration of the call can be utilized to determine the most effective delivery method. For instance, when performing an OTP missed call, it is possible to ascertain whether the call was successful or unsuccessful by listening for or detecting a tone indicating whether the phone was connected or disconnected from the phone.

At least some of the above-described methods/steps may be stored as instructions in a non-transitory computer readable storage medium that, when executed, cause at least one computer processor to execute the above-described functions/steps/methods of the central proxy, end user, service user, and/or channel vendor.

Embodiments of the present disclosure provide certain advantages including but not limited as follows. The present disclosure provides a system and method which dynamically optimizes verification process, e.g. optimizes OTP channel recommendation based on optimization criteria including service user's priorities, and attributes of OTP channel including static and/or non-static, e.g. real-time, indicators; filters end user identity and/or other data to ensure relevant data; implements a retry procedure, either automatic or manual, if previous verification attempts fails which retry procedure is adapted to change based on delivery state or existing data; auto-populate OTP entry such as for missed call OTP by intelligently scanning the phone call history to streamline the verification procedure. Furthermore, the central proxy provides a single platform integrating multiple service users and OTP channels by providing same integration mechanisms across various service users and OTP channels so that changes, e.g. activation and deactivation of channel vendors, vendor selection, and OTP channel selection, may be carried out in an integrated, convenient, and prompt manner. As such, an easy integration flow for verification in application using many channels in one service is provided. Accordingly, the foregoing features result in an optimal, precise, and/or economical verification flow which also increases verification success rates by utilizing the most appropriate, cost-effective, and convenient technique and flow for the user. In particular, an easy integration flow for verification in application using many channels in one service is provided. Furthermore, the central proxy provides easy smart switching for activated channel manually and/or automatically.

It is to be understood that the embodiments and features described above should be considered exemplary and not restrictive. Many other embodiments will be apparent to those skilled in the art from consideration of the specification and practice of the invention. Furthermore, certain terminology has been used for the purposes of descriptive clarity, and not to limit the disclosed embodiments of the invention.

1. A method for one time password (OTP) channel optimization, the method comprising:
for each of a plurality of optimization criteria, and based on at least one attribute of a plurality of OTP channels, ascertaining a recommendation of the OTP channels, thereby ascertaining a plurality of recommendations for the plurality of optimization criteria respectively;
in response to a verification request comprising an end user identifier, and based on at least one attribute of the end user identifier, selectively providing a first recommendation having at least some of the OTP channels, wherein the recommendations include the first recommendation;
in response to an end user selected first OTP channel which is included in the at least some of the OTP channels of the first recommendation, instructing for a first OTP to be provided via the first OTP channel to a first device associated with the end user identifier wherein the OTP channels include the first OTP channel; and
validating a first OTP entry against the first OTP.

2. The method of claim 1, further comprising:
in response to and based on a failed validation of the first OTP, selectively providing a second recommendation wherein the recommendations include the second recommendation;
in response to a selected second OTP channel which is included in the second recommendation, instructing for a second OTP to be provided via the second OTP channel to the first device or a second device associated with the end user identifier wherein the OTP channels include the second OTP channel.

3. The method of claim 2, further comprising:
based on a validation outcome of the first OTP and/or the second OTP, modifying the at least one attribute of the OTP channels.

4. The method of claim 1, further comprising:
in response to and based on a failed validation of the first OTP, ascertaining an OTP entry of the failed validation is similar to the first OTP;
instructing for another OTP to be provided via the first OTP channel to the first device associated with the end user identifier.

5. The method of claim 1, wherein instructing for a first OTP to be provided via the first OTP channel to a first device associated with the end user identifier includes instructing for the first OTP to be auto-populated as OTP entry.

6. The method of claim 1, wherein the optimization criteria include at least two selected from the group of: security of OTP channel, accessibility of OTP channel, success rate of OTP channel, and usage cost of OTP channel.

7. The method of claim 1, wherein the at least one attribute of the plurality of OTP channels is selected from the group of: static OTP channel characteristic, real-time usage cost of OTP channel, delivery rate of OTP channel, validation success rate of OTP channel, and usability of OTP channel.

8. The method of claim 1, wherein the at least one attribute of the end user identifier includes a count of OTP authentication attempts associated with the end user identifier over a predetermined time period.

9. The method of claim 1, further comprising:
validating the end user identifier against a database which includes a historical profile associated with the end user identifier,
based on the historical profile, prioritizing or de-prioritizing the end user identifier.

10. The method of claim 1, wherein the OTP channels include at least two selected from the group of: SMS, voice call, missed call, messaging application, authenticator application, electronic mail.

11. The method of claim 1, wherein the first OTP is a missed call, the method further comprising: automatically providing at least a part of a caller number of the missed call as the first OTP entry, wherein the missed call is received within a predetermined duration or count.

12. The method of claim 11, further comprising:
optimizing a success rate of missed call OTP by performing at least one of the following:
monitoring a delivery status of the first OTP,
detecting a dial tone, a busy tone or a voice, and
ascertaining a duration of the missed call.

13. A central proxy comprising:
at least one computer processor, a memory storage which is communicably coupled thereto and stores computer executable instructions that, when executed by the computer processor, cause the computer processor to:
for each of a plurality of optimization criteria, and based on at least one attribute of a plurality of one time password (OTP) channels, ascertains a recommendation of the OTP channels, thereby ascertaining a plurality of recommendations for the plurality of optimization criteria respectively;
in response to a verification request comprising an end user identifier, and based on at least one attribute of the end user identifier, selectively provide a first recommendation having at least some of the OTP channels, wherein the recommendations include the first recommendation;
in response to an end user selected first OTP channel which is included in the first recommendation, instruct for a first OTP to be provided via the first OTP channel to a first device associated with the end user identifier wherein the OTP channels include the first OTP channel; and
validate a first OTP entry against the first OTP.

14. The central proxy of claim 13, wherein the computer processor is further configured to:
in response to and based on a failed validation of the first OTP, selectively provide a second recommendation wherein the recommendations include the second recommendation;
in response to a selected second OTP channel which is included in the second recommendation, instruct for a second OTP to be provided via the second OTP channel to the first device or a second device associated with the end user identifier wherein the OTP channels include the second OTP channel.

15. The central proxy of claim 14, wherein the computer processor is further configured to:
based on a validation outcome of the first OTP and/or the second OTP, modify the at least one attribute of the OTP channels.

16. The central proxy of claim 13, wherein the computer processor is further configured to:
in response to and based on a failed validation of the first OTP, ascertain an OTP entry of the failed validation is similar to the first OTP;
instruct for another OTP to be provided via the first OTP channel to the first device associated with the end user identifier.

17. The central proxy of claim 13, wherein the computer processor is further configured to: instruct for the first OTP to be auto-populated as OTP entry.

18. The central proxy of claim 13, wherein the optimization criteria include at least two selected from the group of: security of OTP channel, accessibility of OTP channel, success rate of OTP channel, and usage cost of OTP channel.

19. The central proxy of claim 13, wherein the at least one attribute of the plurality of OTP channels is selected from the group of: static OTP channel characteristic, real-time usage cost of OTP channel, delivery rate of OTP channel, validation success rate of OTP channel, and usability of OTP channel.

20. The central proxy of claim 13, wherein the at least one attribute of the end user identifier includes a count of OTP authentication attempts associated with the end user identifier over a predetermined time period.

21. The central proxy of claim 13, wherein the computer processor is further configured to:
validate the end user identifier against a database which includes a historical profile associated with the end user identifier,
based on the historical profile, prioritize or de-prioritize the end user identifier.

22. The central proxy of claim 13, wherein the OTP channels include at least two selected from the group of: SMS, voice call, missed call, messaging application, authenticator application, electronic mail.

23. A non-transitory computer-readable storage medium having stored thereon instructions that, when executed, cause at least one computer processor to perform the method of claim 1.
